(19) United States
(12) Patent Application Publication
(10) Pub. No.: US 2008/0054993 A1
(43) Pub. Date: Mar. 6, 2008

(54) Amplifier apparatus and method

(76) Inventor: Tahir Rashid, Berkshire (GB)

Correspondence Address: DICKSTEIN SHAPIRO LLP, 1825 EYE STREET NW, Washington, DC, 20006-5403, US

(21) Appl. No.: 11/785,703

(22) Filed: Apr. 19, 2007

(30) Foreign Application Priority Data
Aug. 31, 2006 (GB) 0617200.1

(51) Int. Cl. G05F 3/02

(52) U.S. Cl. 327/538

(57) ABSTRACT

An amplifier power-down apparatus is provided for reducing transient signals in an audio circuit comprising a reference voltage generator circuit for generating a reference voltage. The reference voltage generator circuit comprises a capacitor for maintaining the reference voltage at a desired level. The amplifier power-down apparatus comprises a discharge control circuit for controlling the operation of the reference voltage generator circuit during power-down. The discharge control circuit comprises a switching device for controlling the discharging of the capacitor, wherein the switching device is controlled by a pulsed signal. The pulsed signal is a pulse width modulated (PWM) signal in which the pulse width is proportional to the voltage level of the reference voltage being discharged.

### RELATED APPLICATIONS

The present application is related to co-pending application H0222.0002/P002, which has been filed concurrently herewith.

### BACKGROUND OF THE INVENTION

1. Field of the Invention

The invention relates to an amplifier apparatus and method for reducing unwanted transient signals, and in particular to an amplifier power-down apparatus and method for reducing unwanted audible signals generated by transient signals in an audio amplifier circuit.

2. Description of the Related Art

“Click” and “pop” are terms used to describe unwanted audio-band transient signals that are heard in a headphone or a speaker when an audio amplifier is enabled or disabled.

In portable audio applications power consumption is a key issue, which means that circuit components, such as audio amplifiers, are often disabled or powered down when not required. This can lead to unwanted audio-band transient signals being produced each time an audio amplifier is powered down or placed in a sleep or hibernation mode. Similar problems can also arise in other non-portable applications.

Click and pop problems are particularly problematic in single supply amplifiers that have to charge to a certain defined voltage during power up, which then has to be discharged during power-down.

FIG. 1 shows a known audio amplifier circuit 1 for driving a load 2, for example a headphone or a speaker, coupled to an output terminal 3. An output amplifier 5 receives an audio signal at a first input terminal 7 from an audio source, such as a mixer 9. It will be appreciated that the mixer 9 receives an audio signal from a DAC (not shown) or other signal source. The amplifier 5 also receives a reference voltage V_{MID} at a second input terminal 11. In order for the output signal of the amplifier to achieve maximum swing, either side of its quiescent output voltage, this quiescent voltage is set midway between the supply voltages VDD and ground (GND). The quiescent voltage is set by an applied reference voltage V_{MID}, equal to VDD/2.

The reference voltage V_{MID} is produced by a reference voltage generator circuit 13. As will be described in greater detail below, a transient signal may be produced when the reference voltage generator circuit 13 is powered down, thereby causing an unwanted “pop” being transmitted to the headphone or speaker. Transient signals can also be produced when powering up the reference voltage generator circuit. It is noted that the present application is concerned with reducing or eliminating the effects of unwanted transient signals during power down. Co-pending application ID-06-005 is concerned with reducing or eliminating the effects of unwanted transient signals during power up, or during both power up and power down.

It is noted that control logic 10 is provided for controlling the operation of the output amplifier 5 during power down and mute operations. For example, the control logic 10 provides a control signal S₁ for controlling the reference generator circuit 13, a control signal S₂ for controlling the amplifier 5 (for example when performing a mute operation), and a control signal S3 for controlling a buffer circuit 14. The buffer circuit 14 buffers the reference voltage V_{MID} received from the reference voltage generator circuit 13. It is noted that the buffer circuit 14 is not essential to the functional operation of the amplifier circuit.

FIG. 2 illustrates an example of a power-down sequence for an audio amplifier according to the prior art. The first step, step 201, involves muting the output amplifier 5 using the control signal S₂ of the control logic 10. In the mute state the output is unaffected by the input signal, for example by interrupting the signal path using a switch. Next, circuit components upstream of the output amplifier 5 are disabled, for example the mixer 9, DAC (not shown), etc., step 203. After the upstream circuitry has been disabled, the reference voltage generator circuit 13 that produces the reference voltage V_{MID} is then disabled, step 205. This is performed, for example, by opening the switch 131 of FIG. 1 using control signal S₁ from the control logic 10.

There is a delay while the reference voltage V_{MID} falls to 0 v, step 207. This delay can take approximately 1 second depending on the total capacitive load. Once the reference voltage V_{MID} has fallen to 0 v, the output amplifier 5 is then disabled or powered down, step 209.

When performing a power-down sequence such as that described above, a “pop” can be heard when the reference voltage V_{MID} begins to discharge to ground, as will be described in further detail below.

FIG. 3 shows a typical reference voltage generator circuit 13 for producing the reference voltage V_{MID}. The reference voltage V_{MID} can be produced using a potential divider circuit, for example, that comprises resistive elements 137 and 139. If the voltage level of the reference voltage is chosen to be VDD/2, then the resistive elements 137 and 139 will have equal values. It will be appreciated that the resistive elements 137 and 139 would have different values if a different reference voltage was required. A decoupling capacitor 135 is connected across resistive element 139. It is noted that, in the case of an integrated circuit arrangement, the decoupling capacitor 135 may be provided off-chip, if desired, and is used to decouple the V_{MID} node 133. A switch 131 is provided for enabling and disabling the reference voltage generator circuit 13 under control of the control signal S₁.

FIG. 4 shows the reference voltage V_{MID} at node 133 during power-down of the amplifier circuit 1. When the reference voltage generator circuit 13 is switched off at t_{OFF}, the decoupling capacitor 135 begins to discharge to ground, which results in a slope discontinuity or rapid change in the reference voltage V_{MID} across capacitor 135. The slope discontinuity in the reference voltage V_{MID} produces audible signal components that propagate through to the output terminal 3 and onto the load 2. As the decoupling capacitor 135 continues to discharge, the fall in voltage level of the reference voltage V_{MID} becomes more gradual until the decoupling capacitor 135 is fully discharged. This slope discontinuity of the reference voltage V_{MID} at t_{OFF} is what causes the audible pop.

When the switch 131 is opened the capacitor 135 discharges through resistor 139. Therefore, one method of reducing the pop would be to make the value of resistor 139 very large. However, since the total time taken to discharge the capacitor 135 depends on the value of resistor 139, increasing the value of resistor 139 would have the corresponding disadvantage of increasing the discharge time, which would be unacceptable for most applications. In contrast, if the value of resistor 139 is scaled to have a desired discharge time in the order of about 200 ms, the initial discharge rate is very high and the pop very audible.

It is therefore an aim of the present invention to provide an amplifier power-down apparatus and method for reducing unwanted signals in an audio circuit.

### SUMMARY OF THE INVENTION

According to a first aspect of the invention, there is provided an amplifier power-down apparatus for reducing transient signals in an audio circuit comprising a reference voltage generator circuit for generating a reference voltage, the reference voltage generator circuit comprising a capacitor for maintaining the reference voltage at a desired level. The apparatus comprises a switching device for discharging the capacitor, and a discharge control circuit for controlling the operation of the switching device during power-down. The discharge control circuit comprises circuitry for providing a pulsed signal for controlling the switching device, and hence the rate at which the capacitor is discharged.

The amplifier power-down apparatus has the advantage of reducing audible transient signals during power-down of an audio amplifier.

According to another aspect of the present invention, there is provided a method of reducing transient signals in an amplifier power-down apparatus for an audio circuit comprising a reference voltage generator circuit for generating a reference voltage, the reference voltage generator circuit comprising a capacitor for maintaining the reference voltage at a desired level. The method comprises the steps of providing a switching device for discharging the capacitor, and controlling the operation of the switching device during power-down by providing a pulsed signal for controlling the switching device, and hence the rate at which the capacitor is discharged.

According to further aspects of the invention, there are provided various systems employing the apparatus defined in the claims. These include, but are not limited to, audio apparatus, portable audio apparatus, headphone amplifiers, headphones, communications apparatus (e.g. mobile phones), and in-car audio apparatus.

### BRIEF DESCRIPTION OF THE DRAWINGS

For a better understanding of the present invention, and to show more clearly how it may be carried into effect, reference will now be made, by way of example only, to the following drawings in which:

FIG. 1 shows an audio circuit according to the prior art;

FIG. 2 describes a typical power-down sequence for the circuit shown in FIG. 1;

FIG. 3 shows a reference voltage generator circuit according to the prior art;

FIG. 4 is a graph showing how the reference voltage discharges during power-down in a prior art circuit;

FIG. 5 shows a reference voltage generator circuit having an amplifier power-down apparatus according to a first embodiment of the present invention;

FIGS. 6a and 6b show how the PWM signal 184 of FIG. 6b is formed using the saw-tooth waveform and V_{MID} signal of FIG. 6a during a power-down operation;

FIG. 7 is a graph showing the reference voltage during power-down;

FIG. 8 shows a reference voltage generator circuit having an amplifier power-down apparatus according to a second embodiment of the present invention;

FIG. 9 is a graph showing the reference voltage during power-down, and further illustrating the first and second periods of operation;

FIG. 10 shows an example of a typical application of the present invention;

FIG. 11 shows a further example of a typical application of the present invention;

FIG. 12 shows a further example of a typical application of the present invention; and

FIG. 13 shows a further example of a typical application of the present invention.

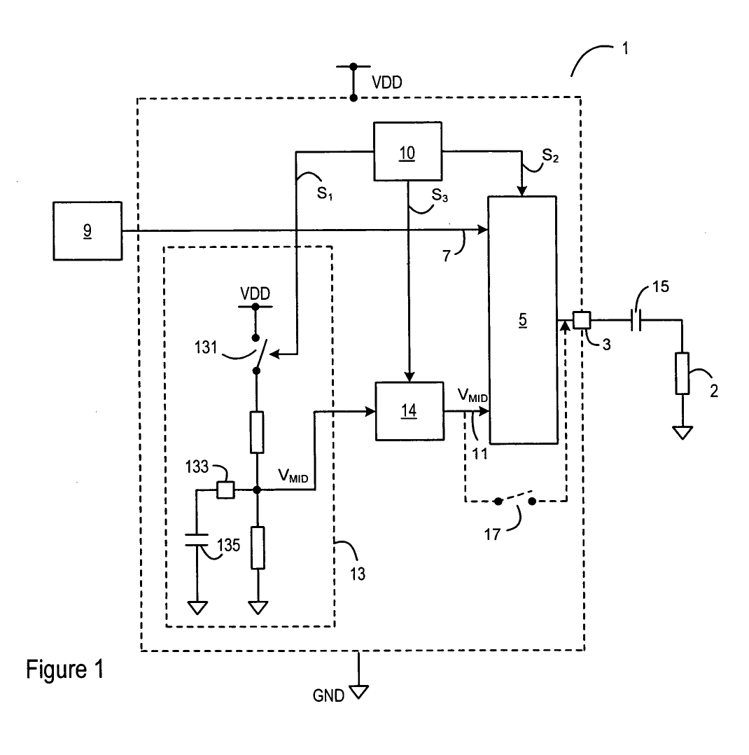

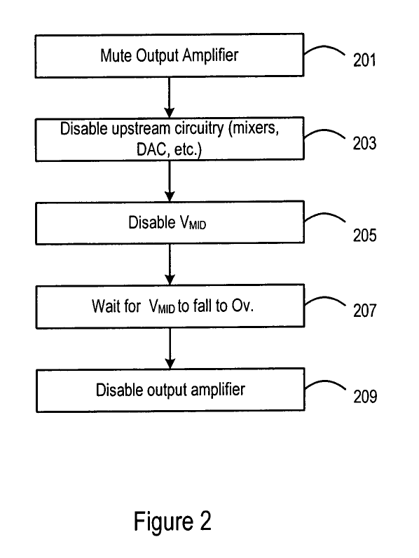

### DETAILED DESCRIPTION OF THE PREFERRED EMBODIMENT

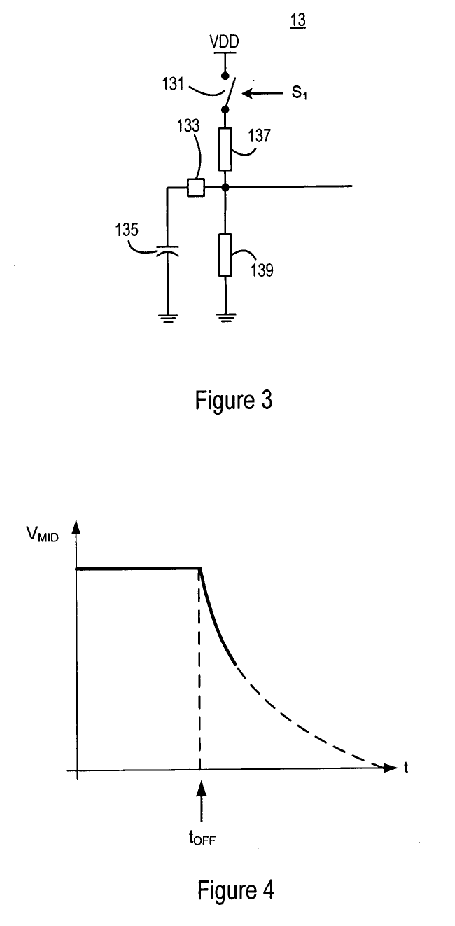

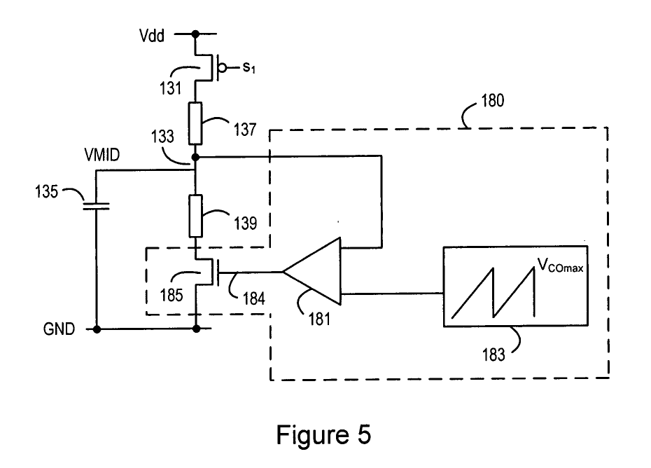

Referring to FIG. 5, there is shown an amplifier power-down apparatus according to a first embodiment of the present invention. In a similar manner to FIG. 3, a reference voltage generator circuit 13 for producing a reference voltage V_{MID} comprises a potential divider circuit comprising resistive elements 137 and 139. The resistive elements 137 and 139 can be chosen, for example, to provide a reference voltage that is mid-way between the supply rails of VDD and ground. A decoupling capacitor 135 is connected across resistive element 139. The decoupling capacitor 135 acts to maintain the reference voltage at a desired voltage level during operation. The decoupling capacitor 135 may be provided off-chip, if desired, and is used to decouple the V_{MID} node 133.

However, as will be described below, rather than merely using the switch 131 to disable or power-down the reference voltage generator circuit 13, an amplifier power-down apparatus comprising a discharge control circuit 180 is provided for discharging the reference voltage V_{MID} in a controlled manner.

The discharge control circuit 180 comprises a switching device 185, for example an NMOS transistor, for controlling the discharge of current from the capacitor 135 to ground during a power-down operation. It will be appreciated that other switching devices could be used, such as PMOS or bipolar devices.

The switching transistor 185 is controlled by a comparator 181. The comparator 181 is connected to receive the reference voltage V_{MID} at a first input terminal (i.e. the reference voltage that is being controlled is provided as one input). The comparator 181 is connected to receive a comparison waveform on a second input terminal. The comparison waveform is preferably a saw-tooth waveform received from a saw-tooth generator 183, which can be provided on-chip, or can be received from an external source. A typical frequency for the saw-tooth waveform is about 100 kHz, although it will be appreciated that other frequencies can also be used. It will also be appreciated that other suitable waveforms could be used, including other symmetrical or non-symmetrical waveforms that repetitively scan across the range of the anticipated input signal, provided such signals have at least one edge having a slew rate. Other such examples include sine-wave or triangular shaped waveforms.

When the reference voltage generator circuit is in a powered-up state, and the capacitor 135 is in a charged state, the voltage V_{MID} at node 133 corresponds to the desired reference voltage, say VDD/2. When the circuit is to be powered-down or turned off, the discharge control circuit 180 controls the discharge of current from capacitor 135 in the following manner.

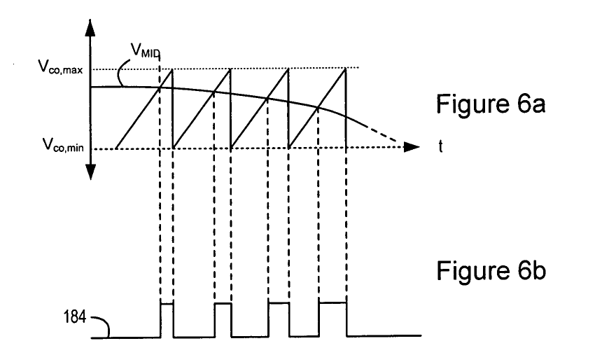

The reference voltage V_{MID} is applied to the first input of the comparator 181, with the comparison waveform, i.e. saw-tooth waveform, applied to the second input terminal. The peak value V_{COmax} of the comparison or saw-tooth waveform is set to V_{MID} or slightly higher. Since the voltage at node 133 will be high, i.e. the reference voltage V_{MID}, the output signal 184 from comparator 181 will initially consist of narrow pulses as shown in FIG. 6b. This is because the voltage level of the saw-tooth waveform will only be higher than the voltage level of the reference voltage V_{MID} for relatively short periods of time. This will result in the NMOS transistor 185 being switched on for short periods of time, thereby allowing the voltage at node 133 to begin decaying at a relatively slow rate.

However, as the reference voltage V_{MID} begins to fall, the pulse widths of the output signal 184 from the comparator 181 will become wider, as shown in FIG. 6b. This in turn results in the NMOS transistor 185 becoming switched on for longer periods of time, which results in the voltage falling more rapidly. The discharge control circuit 180 therefore provides an acceleration effect that takes place due to the feedback arrangement.

It is noted that FIGS. 6a and 6b are provided to illustrate the principles of operation of the discharge control circuit 180. It will be appreciated that, in reality, the discharge control circuit 180 will produce significantly more pulses than those shown in FIGS. 6a and 6b.

It will also be appreciated by a person skilled in the art that the connection of the inputs to the comparator 181 will depend on whether a NMOS or PMOS transistor is used as the switching device 185 (and also the configuration of the comparison waveform itself, and that other circuit components may therefore be required to provide a suitable pulsed signal for controlling the transistor 185 (for example the use of inverting buffers to provide the required signals).

From the above it can be seen that the comparator 181 generates a pulse width modulated (PWM) signal 184, in which the pulse widths are proportional to the voltage level of the reference voltage that is being controlled.

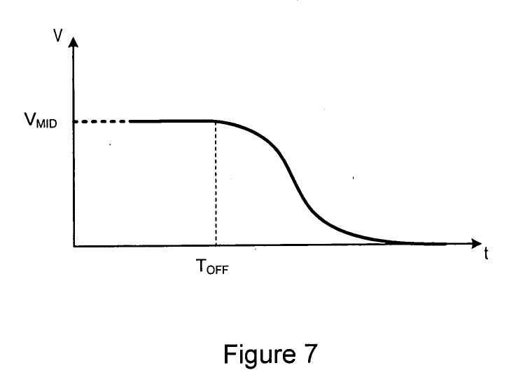

When V_{MID} falls below the voltage of the minima V_{CO,min} of the saw-tooth waveform the transistor 185 will become turned hard-on continuously. Thus, the circuit of FIG. 5 operates in a first mode of operation during a first period, and a second mode of operation during a second period. In the first mode of operation the discharging of the capacitor 135 is controlled via the feedback path comprising the comparator 181, resistor 139 and transistor 185. As such, in the first period of operation, the average discharge current will increase as the duty cycle of the switch increases. In the second mode of operation the discharging of the capacitor is based on the RC time constant of resistor 139 in parallel with capacitor 135. As a result, a smooth S-shape V_{MID} waveform will be generated, as illustrated in FIG. 7.

The slope discontinuity, or deviation, at T_{OFF} is no longer exhibited and, instead, the reference voltage V_{MID} discharges in a smoother and more controlled manner, thereby minimising or suppressing the high frequency components associated with the prior art waveform which causes “click” or “pop” effects on the output of the amplifier. After the initial gradual and smooth fall in the slope of the reference voltage V_{MID}, the reference voltage then falls more rapidly, followed by another gradual and smooth transition to ground as the capacitor 135 completes its discharging process.

It will therefore be appreciated that the embodiment of FIG. 5 has the advantage of reducing and preferably preventing unwanted audio-band signals caused by the slope discontinuity of V_{MID} from causing undesired “pop” sounds during power-down of the reference voltage generator circuit, while still allowing the reference voltage generator circuit to be discharged in a timely manner.

To ensure that operation of the discharge control circuit will commence properly (i.e. despite circuit non-idealities such as offset voltages), the comparator may be designed to have a small consistent offset, or a switched current sink (not shown) may be connected to V_{MID}, directly or via resistor 139, to start to pull V_{MID} down. Alternatively, the comparison saw-tooth waveform may be offset in voltage. In each case an initial transient may occur, but this will only be small, since the additional offset or current need only be just sufficient to overcome any small non-idealites such as comparator input offsets.

Since power consumption is an increasingly important factor, especially in relation to portable audio devices such as portable music players, it will be appreciated that the discharge control circuit 180 is preferably turned off after the initial power-down mode of operation in order to conserve power.

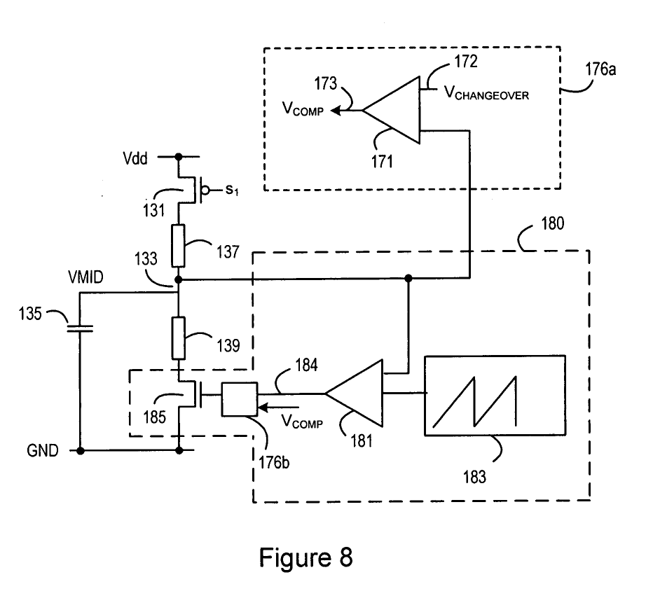

FIG. 8 shows an example of such a circuit according to another embodiment of the present invention, which provides a means of disabling the discharge control circuit 180 during power-down. In a similar manner to FIG. 5, the reference voltage generator circuit comprises a potential divider circuit comprising resistive elements 137 and 139. A decoupling capacitor 135 is connected across resistive element 139.

The discharge control circuit 180 comprises a switching device 185, for example an NMOS transistor, for controlling the discharge of current from the capacitor 135 to ground during a power-down operation.

A comparator 181 is connected to receive the reference voltage V_{MID} at a first input terminal (i.e. the reference voltage that is being controlled is provided as one input). The comparator 181 is connected to receive a comparison waveform on a second input terminal. The comparison waveform is preferably a saw-tooth waveform received from a saw-tooth generator 183.

According to the embodiment of FIG. 8, changeover circuitry 176a, 176b is provided for controlling transistor 185. In particular, the transistor 185 can be controlled using changeover circuitry 176b which receives the normal output 184 from comparator 181, and an output signal 173 (V_{COMP}) from a comparator 171 of the changeover circuitry 176a. The comparator 171 receives the reference voltage V_{MID} on a first input and a threshold voltage 172 (V_{CHANGEOVER}) on a second input. The comparator is therefore configured to provide a switching signal when the reference voltage V_{MID} reaches a predetermined threshold, such as VDD/4. The changeover circuitry 176b is configured to keep switch 185 turned on after or while this signal is received. Depending on signal polarities, this could be a simple NOR gate for example. In this way, the comparator 181, comparison waveform generator 183 and associated circuitry are used to control the switch 185 during a first period of the power-down operation, with the comparator 171 and the changeover circuitry 176b being used to control transistor 185, keeping it switched on regardless of any output from comparator 181, during a second period of operation. In this manner, the comparator 181 and associated circuitry can be disabled during the second period of operation, such that only the comparator 171 and the changeover circuitry 176b consume power, rather than the entire components within the discharge control circuit 180.

Although not illustrated, 176b could be modified, as will be appreciated by those skilled in the art, to latch the output from comparator 171 once it has switched, thereby enabling the comparator 171 to be powered down.

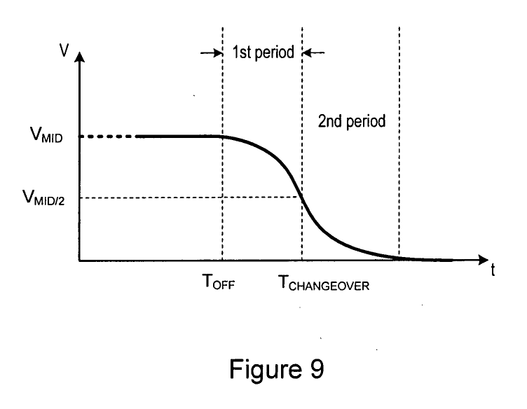

FIG. 9 further illustrates the operation of the amplifier power-down apparatus during the first and second periods of operation described above.

The embodiments described above have the advantage of reducing and potentially preventing unwanted audio-band signals caused by non-smooth changes of V_{MID} from causing undesired audible artefacts during power-down of the reference voltage generator circuit, while still allowing the reference voltage generator circuit to discharge in a timely manner.

It will be appreciated that the discharge control circuit can be used with other types of reference voltage generator circuits known to those skilled in the art, other than the potential divider circuit shown in the preferred embodiment.

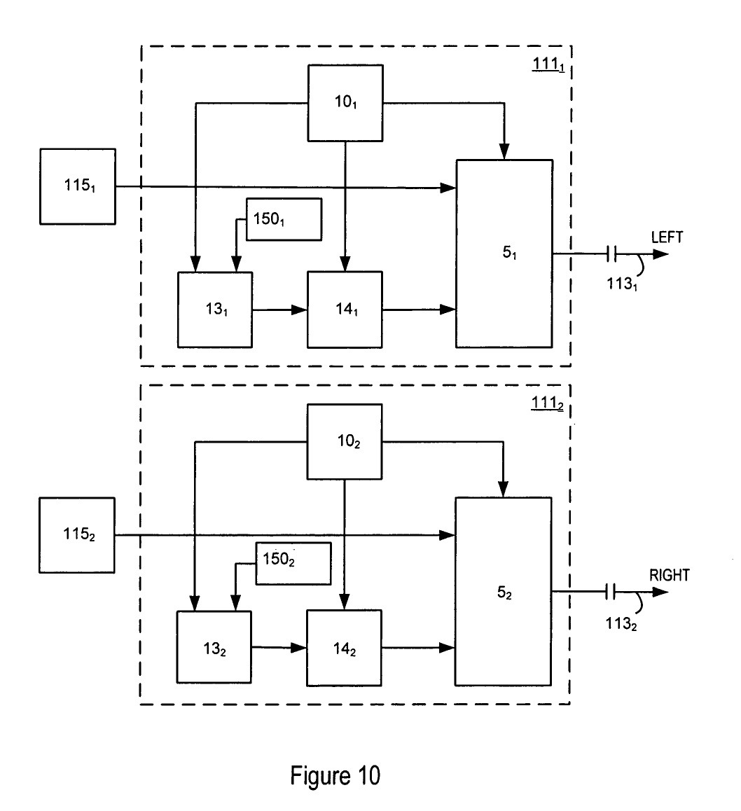

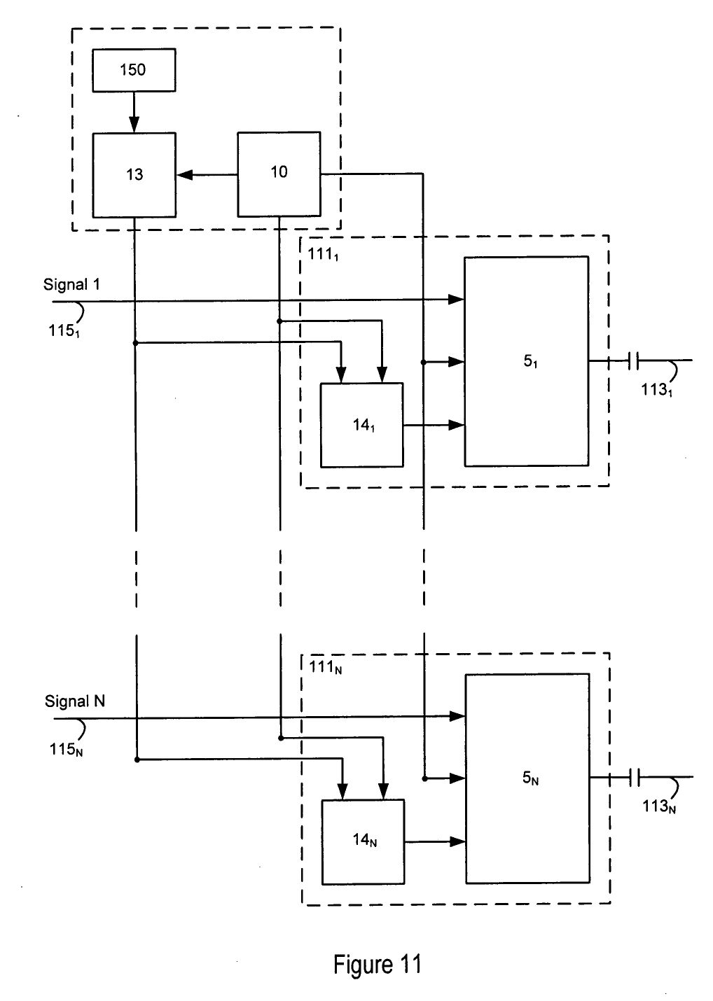

While the preferred embodiment has been described in relation to an amplifier circuit that produces one audio output signal, the invention is equally applicable with audio circuits that produce multiple audio output signals, for example a stereo system as shown in FIG. 10. In FIG. 10 the audio system comprises a first audio amplifier circuit 111₁ for producing a first audio output signal 113₁ (e.g. left output) from a first source 115₁, and a second audio amplifier circuit 111₂ for producing a second audio output signal 113₂ (e.g. right output) from a second source 115₂. FIG. 10 is shown as having separate controls 10₁ and 10₂ for audio amplifiers 5₁ and 5₂. However, it is noted that audio amplifiers 5₁ and 5₂ could operate from a single common control 10. Also, while FIG. 10 shows separate V_{MID} reference voltage generators 13₁ and 13₂, audio amplifiers 5₁ and 5₂ could operate from a single common reference voltage generator 13. It will be appreciated that a single or two amplifier power-down circuits according to the present invention will be employed depending upon whether the system of FIG. 10 comprises one or two V_{MID} reference voltage generators 13₁ and 13₂.

In addition, the invention can be used with an audio system as shown in FIG. 11, relating to a system having a plurality of outputs as used in home cinema applications (for example Dolby™ pro logic 5.1). A single V_{MID} reference voltage generator 13 and a single control logic 10 has been shown as controlling multiple audio amplifiers 5₁ to 5_{N}, each providing a separate output signal 113₁ to 113_{N} based on input signals 115₁ to 115_{N}. It is noted that the separate buffers 14₁ to 14_{N} in FIG. 11 could also be replaced by a single buffer 14.

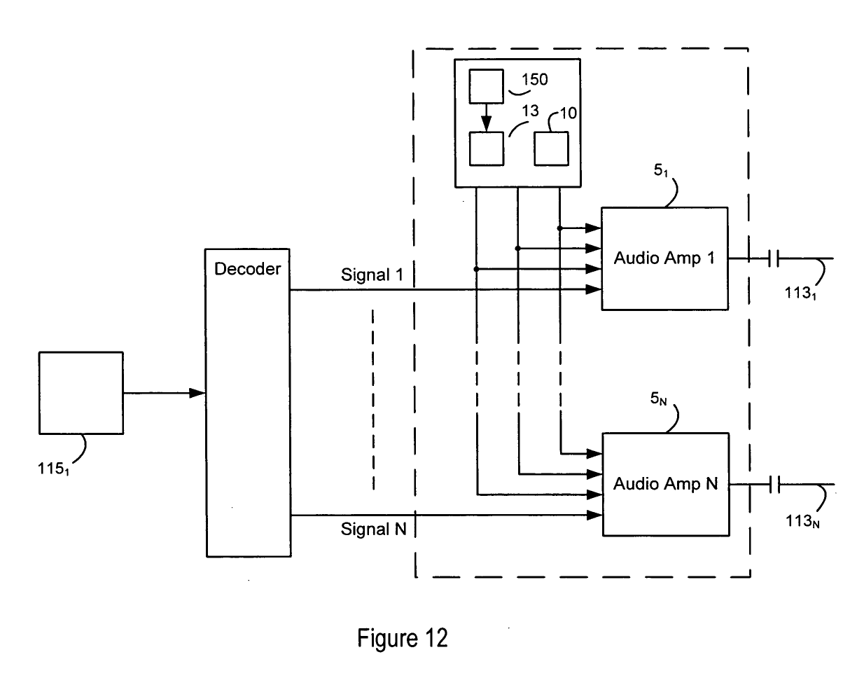

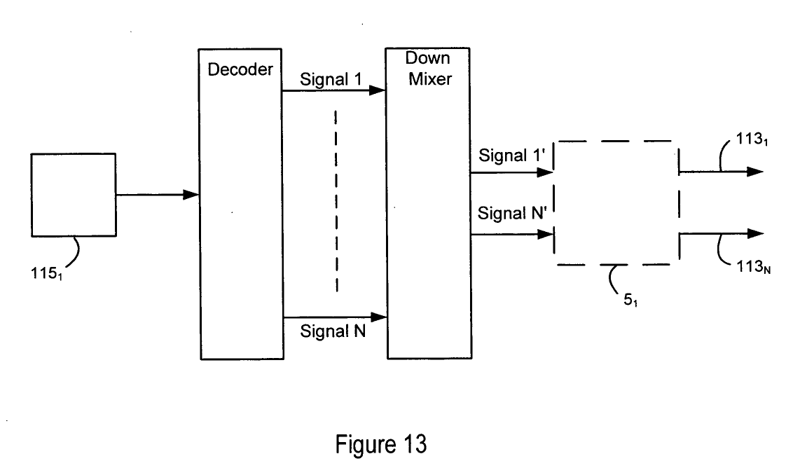

FIGS. 12 and 13 show further typical applications in which the invention can be used. FIG. 12 shows a system in which N input signals are shown as being derived from a Decoder, such as a Dolby™ Decoder, that is used to decode time multiplexed audio signals from a DVD, for example. FIG. 13 shows a system in which N signals from a decoder are fed into a Down Mixer such that signals 1 to N are mixed to form signals 1′ to N′ (where N′<N). For example, signals 1 to N may be the six signals associated with a home cinema system and signals 1′ to N′ may be left and right stereo signals which are used to produce stereo output signals 1′ and N′.

It will be appreciated by a person skilled in the art that the references to NMOS transistors could be implemented by other switching devices, and in other configurations providing the same end result. For example, the NMOS switching device 185 of FIG. 5 could be replaced by a PMOS device, provided that the comparator 181 is adapted to provide a corresponding control signal. In other words, if the comparator 181 is configured to drive a PMOS transistor 185, then the output 184 of the comparator would be normally high, with the “narrow” pulses being narrow pulses to ground, as opposed to the narrow pulses shown in FIG. 6b. Similar alternatives apply to other switching devices of the preferred embodiments

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single element or other unit may fulfil the functions of several units recited in the claims. Any reference signs in the claims shall not be construed so as to limit their scope.

What is claimed is:

1. An amplifier power-down apparatus for reducing transient signals in an audio circuit comprising a reference voltage generator circuit for generating a reference voltage, the reference voltage generator circuit comprising a capacitor for maintaining the reference voltage at a desired level, the apparatus comprising:
a switching device for discharging the capacitor; and
a discharge control circuit for controlling the operation of the switching device during power-down;
wherein the discharge control circuit comprises circuitry for providing a pulsed signal for controlling the switching device, and hence the rate at which the capacitor is discharged.

2. An apparatus as claimed in claim 1, wherein the discharge control circuit is configured to operate in a first mode of operation during a first period, and a second mode of operation during a second period.

3. An apparatus as claimed in claim 2, wherein the discharge control circuit is adapted to provide a pulse width modulated signal for controlling the switching device during the first period of operation.

4. An apparatus as claimed in claim 3, wherein the width of a pulse in the pulse width modulated signal is proportional to the level of the reference voltage being discharged.

5. An apparatus as claimed in claim 3, wherein the discharge control circuit is adapted to provide pulsed signals having narrow pulse widths during the initial stages of a discharging operation, and adapted to increase the pulse widths during the discharging operation.

6. An apparatus as claimed in claim 1, wherein the circuitry for providing the pulsed width modulated signal comprises a first comparator.

7. An apparatus as claimed in claim 6, wherein the first comparator is connected to receive a comparison waveform on a first input terminal, and the reference voltage that is being discharged on a second input terminal.

8. An apparatus as claimed in claim 7, wherein the comparison waveform is a saw-tooth waveform.

9. An apparatus as claimed in claim 7, wherein the operation of the discharge control circuit during the first period is based on a positive feedback path comprising the first comparator, the switching device and a first resistor device in the reference voltage generator circuit.

10. An apparatus as claimed in claim 7, wherein the operation of the discharge control circuit during the second period is based on a RC time constant of the reference voltage generator circuit.

11. An apparatus as claimed in claim 2, wherein the discharge control circuit is configured to be disabled during the second period of operation.

12. An apparatus as claimed in claim 11, further comprising changeover circuitry for controlling the switching device when the discharge control circuit is disabled during the second period.

13. An apparatus as claimed in claim 1, wherein the switching device comprises a transistor.

14. An apparatus as claimed in claim 1, wherein the reference voltage generator circuit comprises a potential divider circuit for producing the reference signal, the potential divider circuit comprising first and second resistors connected in series between a power supply and a ground connection, and the capacitor connected from a node connecting the first and second resistors to ground.

15. A method of reducing transient signals in an amplifier power-down apparatus for an audio circuit comprising a reference voltage generator circuit for generating a reference voltage, the reference voltage generator circuit comprising a capacitor for maintaining the reference voltage at a desired level, the method comprising the steps of:
providing a switching device for discharging the capacitor; and
controlling the operation of the switching device during power-down by providing a pulsed signal for controlling the switching device, and hence the rate at which the capacitor is discharged.

16. A method as claimed in claim 15, further comprising the steps of configuring the discharge control circuit to operate in a first mode of operation during a first period, and a second mode of operation during a second period.

17. A method as claimed in claim 15, further comprising the step of providing a comparator for generating the pulsed signal.

18. A method as claimed in claim 17, wherein the comparator receives a comparison waveform on a first input terminal, and the reference voltage that is being discharged on a second input terminal.

19. A method as claimed in claim 18, wherein the comparison waveform is a saw-tooth waveform.

20. A method as claimed in claim 16, wherein the step of discharging during the first period is based on a positive feedback path comprising the comparator, the switching device and a first resistor device in the reference voltage generator circuit.

21. A method as claimed in claim 16, wherein the step of discharging during the second period is based on a RC time constant of the reference voltage generator circuit.

22. A method as claimed in claim 16, further comprising the step of disabling the discharging control circuit during the second period of operation.

23. An audio apparatus incorporating an amplifier power-down apparatus according to claim 1.

24. A portable audio apparatus incorporating an amplifier power-down apparatus according to claim 1.

25. A headphone amplifier incorporating at least part of an amplifier power-down apparatus according to claim 1.

26. A headphone incorporating an amplifier power-down apparatus according to claim 1.

27. A communications apparatus incorporating an amplifier power-down apparatus according to claim 1.

28. An in-car audio apparatus incorporating an amplifier power-down apparatus according to claim 1.

29. A reference voltage signal for use in an audio circuit, the reference voltage signal configured to have an “S” type shape using the amplifier power-down apparatus according to claim 1.
